(19) United States
(12) Patent Application Publication
(10) Pub. No.: US 2007/0040944 A1
(43) Pub. Date: Feb. 22, 2007

(54) Apparatus and method for correcting color error by adaptively filtering chrominance signals

(75) Inventor: Ki-hyun Hong, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/485,326

(22) Filed: Jul. 13, 2006

(30) Foreign Application Priority Data
Aug. 17, 2005 (KR) 2005-0075445

(51) Int. Cl. H04N 5/00

(52) U.S. Cl. 348/624; 348/631

(57) ABSTRACT

An apparatus for correcting a color error, including: a color error detection unit for detecting the presence or absence of a color error in an edge region of an input video, based on a relation between difference values between interlaced horizontal lines and difference values between non-interlaced horizontal lines of chrominance and luminance signals, respectively; a correction unit for correcting the color error by performing chroma filtering on the chrominance signals of the input video, if the color edge is present in the edge region; and a control unit for controlling the chrominance signals to be outputted after being corrected if the color error is present in the edge region, and for controlling the input chrominance signals to be outputted as they are if the color error is not present in the edge region.

### CROSS-REFERENCE TO RELATED APPLICATIONS

This application claims benefit under 35 U.S.C. § 119 from Korean Patent Application No. 2005-75445, filed on Aug. 17, 2005, the entire content of which is incorporated herein by reference.

### BACKGROUND OF THE INVENTION

1. Field of the Invention

The present invention relates in general to an apparatus for correcting a color error and a method thereof, and more particularly, to an apparatus and method for correcting a color error by detecting a color error and adaptively filtering chrominance signals.

2. Description of the Related Art

Because a chrominance signal has a relatively lower resolution than a luminance signal, chrominance may be sampled at a lower rate of luminance. MPEG defines different chrominance formats, such as, 4:2:0, 4:2:2 and 4:4:4, according to the sampling method of a chrominance signal. For instance, a horizontal scan line on a TV screen is expressed as a ratio of three components: luminance information Y and chrominance information Cb and Cr. In other words, the chrominance formats 4:2:0, 4:2:2 and 4:4:4 are ratios between the horizontal spatial sampling frequencies of a luminance signal Y and two chrominance signals Cb and Cr.

Using the fact that human's eyes are not very sensitive to colors, chrominance information is subsampled to increase the compressibility of data. In 4:4:4 sampling the chrominance information is not subsampled. Meanwhile, in 4:2:2 sampling the chrominance information is subsampled at the half resolution in the horizontal direction, and in 4:2:0 sampling the chrominance information is subsampled at half the rate both vertically and horizontally.

Most MPEG-2 decoders produce a digital video output which is in the 4:2:2 format. Therefore, when an interlaced signal in the 4:2:0 format is inputted, the MPEG-2 must upsample the data to produce an output signal in the 4:2:2 format. Unfortunately, during upsampling for format conversion, an artifact may occur because an incorrect color signal is sampled.

Usually an MPEG-2 video sequence can be encoded as a progressive video sequence or interlaced video sequence. However, when interlaced video is encoded as progressive video, a chrominance sample is sometimes upconverted and an artifact results in a region where a color has shifted in the vertical direction.

To prevent or remove such color error, a low pass filter was traditionally used for interpolation or a local discrete fourier transform (DFT) was computed to compare frequency components. However, the low pass filter is not only incapable of removing the color error completely, but may even make an image appear blurred. Moreover, the local DFT is not easy to implement.

Therefore, there is a need to develop a method for reducing artifacts occurring in an image encoded in the DVD/HDTV format, by accurately detecting and correcting a color error that is caused by post processing for a decoder or independently of the decoder.

### SUMMARY OF THE INVENTION

It is, therefore, an object of the present invention to provide an apparatus and method for correcting a color error to improve picture quality, by detecting a color error based on a relation between a difference value of chrominance signals and a difference value of luminance signals in an edge region of a video and performing adaptive filtering on the color error.

An aspect of the invention provides an apparatus for correcting a color error, including: a color error detection unit for detecting the presence or absence of a color error in an edge region of an input video, based on a relation between difference values between interlaced horizontal lines and difference values between non-interlaced horizontal lines of chrominance and luminance signals, respectively; a correction unit for correcting the color error by performing chroma filtering on the chrominance signals of the input video, if the color edge is present in the edge region; and a control unit for controlling the chrominance signals to be outputted after being corrected if the color error is present in the edge region, and for controlling the input chrominance signals to be outputted as they are if the color error is not present in the edge region.

In an exemplary embodiment, the color error detection unit determines the presence of the color error in the edge region if an average of difference values between interlaced horizontal lines in the chrominance signals is smaller than an average of difference values between non-interlaced horizontal lines in the chrominance signals, and if an average of difference values between interlaced horizontal lines in the luminance signals is greater than an average of difference values between non-interlaced horizontal lines in the luminance signals.

The color error detection unit may include: an edge detection unit for detecting an edge region in the input video; a first and a second calculation unit for calculating a first average, which is the average of difference values between interlaced horizontal lines of the chrominance signals in the edge region, and a second average, which is the average of difference values between non-interlaced horizontal lines of the chrominance signals in the edge region, respectively; a third and a fourth calculation unit for calculating a third average, which is the average of difference values between interlaced horizontal lines of the luminance signals in the edge region, and a fourth average, which is the average of difference values between non-interlaced horizontal lines of the luminance signals in the edge region, respectively; a first comparison unit for comparing the first average with the second average, and for comparing the third average with the fourth average; a first counter for counting the chrominance signals if the first average is smaller than the second average; a second counter for counting the luminance signals if the third average is greater than the fourth average; and a second comparison unit, which determines the presence of the color error if the result of multiplication of the counted value provided by the first counter is greater than the counted value provided by the second counter.

The color error detection unit further may include: a buffer for storing color error information of the input video and of previous input videos, based on the result provided by the second comparison unit; and a determination unit for determining the presence of the color error in the input video if many previous input videos have color errors.

The correction unit may include: a median filtering unit for performing median filtering on chrominance signals of the input video; and a range filtering unit for performing range filtering on the median filtered chrominance signals by applying weights adaptively to the magnitude of the luminance signal.

Another aspect of the present invention provides a method for correcting a color error, which the method includes: detecting the presence or absence of a color error in an edge region of an input video, based on a relation between difference values between interlaced horizontal lines and difference values between non-interlaced horizontal lines of chrominance and luminance signals, respectively; correcting the color error by performing chroma filtering on the chrominance signals of the input video, if the color edge is present in the edge region.

In the detecting step, the presence of the color error in the edge region may be determined if an average of difference values between interlaced horizontal lines in the chrominance signals is smaller than an average of difference values between non-interlaced horizontal lines in the chrominance signals, and if an average of difference values between interlaced horizontal lines in the luminance signals is greater than an average of difference values between non-interlaced horizontal lines in the luminance signals.

The detecting step may include: detecting an edge region in the input video; calculating a first average, which is the average of difference values between interlaced horizontal lines of the chrominance signals in the edge region, and a second average, which is the average of difference values between non-interlaced horizontal lines of the chrominance signals in the edge region, respectively; calculating a third average, which is the average of difference values between interlaced horizontal lines of the luminance signals in the edge region, and a fourth average, which is the average of difference values between non-interlaced horizontal lines of the luminance signals in the edge region, respectively; comparing the first average with the second average, and for comparing the third average with the fourth average; counting the chrominance signals if the first average is smaller than the second average; counting the luminance signals if the third average is greater than the fourth average; and determining the presence of the color error if the result of multiplication of the counted value provided by the first counter is greater than the counted value provided by the second counter.

The detecting step may further include: storing color error information of the input video and of previous input videos, based on the result provided by the second comparison unit; and determining the presence of the color error in the input video if many previous input videos and the input video have color errors.

The correcting step may include: performing median filtering on chrominance signals of the input video; and performing range filtering on the median filtered chrominance signals by applying weights adaptively to the magnitude of the luminance signal.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram of an apparatus for correcting a color error according to one embodiment of the present invention;

FIG. 2 is a block diagram illustrating a color error detection unit in FIG. 1;

FIG. 3 is a block diagram illustrating a correction unit in FIG. 1;

FIG. 4 is a flow chart explaining a method for correcting a color error according to one embodiment of the present invention;

FIGS. 5A and 5B are drawings for explaining a method for calculating an average of difference values of a chrominance signal and a luminance signal; and

FIGS. 6A and 6B are drawing for explaining a range filtering operation.

### DETAILED DESCRIPTION OF THE EXEMPLARY EMBODIMENTS

An embodiment of the present invention will be described herein below with reference to the accompanying drawings.

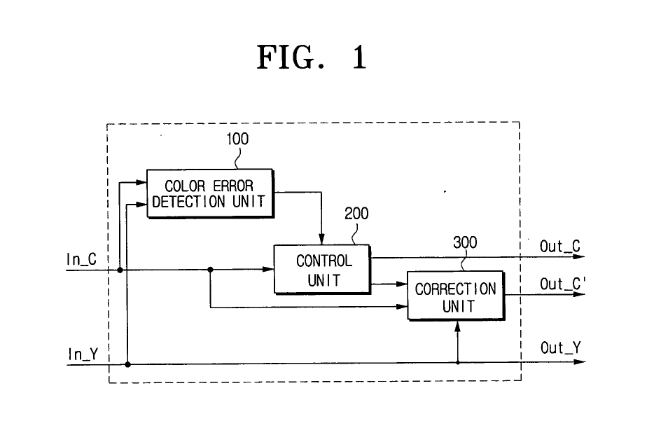

FIG. 1 is a block diagram of an apparatus for correcting a color error according to one embodiment of the present invention.

Referring to FIG. 1, the apparatus for correcting a color error includes a color error detection unit 100, a control unit 200, and a correction unit 300.

The color error detection unit 100 detects whether there is a color error in an edge region based on a difference value between interlaced horizontal lines and a difference value between non-interlaced horizontal lines in a luminance signal and a chrominance signal, respectively, located in an edge region of an input video.

In case a color error exists in the edge region, for chrominance signals the average of difference values between interlaced horizontal lines is smaller than the average of difference values between non-interlaced horizontal lines, whereas for luminance signals the average the average of difference values between interlaced horizontal lines is greater than the average of difference values between non-interlaced horizontal lines. That is, the color error detection unit 100 judges that a color error having an incorrectly upsampled color value exists in an edge region, if the luminance value of a certain pixel is similar to the luminance value of a vertically adjacent pixel whereas the color value of the pixel in question is not similar to the color value of a vertically adjacent pixel but similar to the color value of a pixel spaced apart by a predetermined distance.

Moreover, in an image of which chrominance signal includes a color error, the number of error patterns of the chrominance signal is proportional to the number of edges of the luminance signal. This particular attribute of an image also helps the color error detection unit 100 to detect the color error therein.

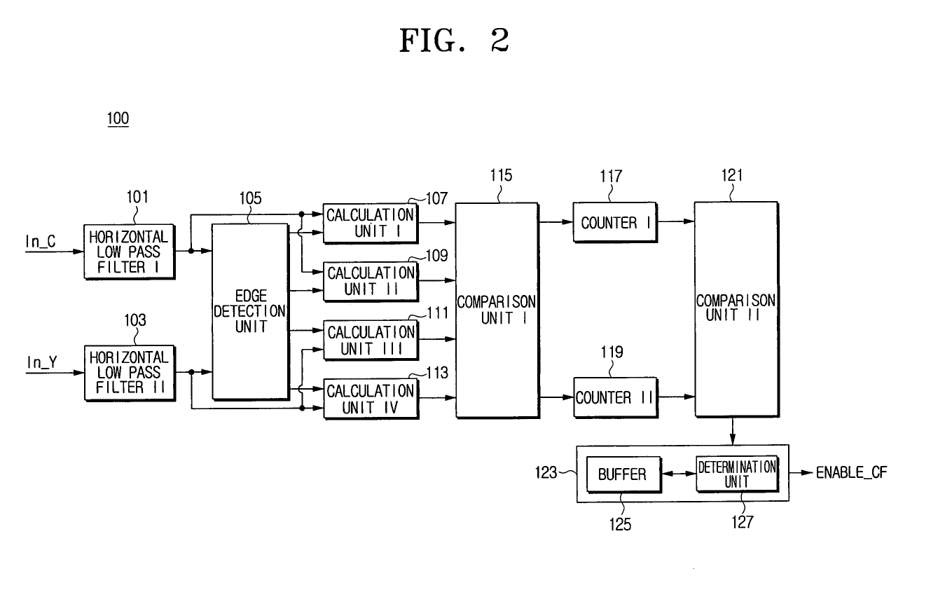

FIG. 2 is a schematic block diagram of the color error detection unit 100 in FIG. 1.

As can be seen in the drawing, the color error detection unit 100 includes a first and a second horizontal low pass filter 101 and 103, an edge detection unit 105, a first through a fourth calculation unit 107, 109, 111 and 113, a first comparison unit 115, a first and a second counter 117 and 119, a second comparison unit 121, and a judgment unit 123.

The first and second horizontal low pass filters perform filtering on the chrominance signal and the luminance signal, respectively, of an input video.

The edge detection unit 105 detects an edge in an input video using a sobel edge detector or a high pass filter. Generally when an input video has a color error, the color component at the edge region does not look smooth but creates an alternate pattern. Therefore, the edge detection unit 105 can judge the presence of a color error by checking whether the color component is in the alternate pattern.

Each of the first through fourth calculation units 107, 109, 111 and 113 calculates an average of difference values between interlaced horizontal lines and an average of difference values between non-interlaced horizontal lines of a chrominance signal and of a luminance signal in each block unit of the edge region. In detail, the first calculation unit 107 and the second calculation unit 109 calculate a first average which is the average of difference values between interlaced horizontal lines of chrominance signals in the edge region, and a second average which is the average of difference values between non-interlaced horizontal lines of chrominance signals in the edge region, respectively.

Likewise, the third calculation unit 111 and the fourth calculation unit 113 calculate a third average of difference values of a luminance signal between interlaced horizontal lines and a fourth average of difference values of a luminance signal between non-interlaced horizontal lines in the edge region, respectively.

The first comparison unit 115 compares the first average with the second average, and compares the third average with the fourth average.

If the first average is smaller than the second average in a certain block size, the first counter 117 counts one chrominance signal of the central pixel of the block. If the third average is greater than the fourth average, the second counter 119 counts one luminance signal at the central pixel of the block.

The second comparison unit 121 compares the counted value obtained through the first counter 117 with the counted value obtained through the second counter 119.

The judgment unit 123 includes a buffer 125 and a determination unit 127, and judges whether a current input video contains a color error. The buffer 125 stores color error information of video, and the determination unit 127 determines the presence or absence of a color error in a current input video, based on the comparison result provided from the second comparison unit 121 and the color error information (e.g., history) of previous videos inputted previously to the current input video in the buffer 125.

In more detail, the determination unit 127 determines the presence or absence of a color error by finding out whether the result of a multiplication, i.e., the product of a constant and the number of pixels, of which average of difference values between interlaced horizontal lines in a chrominance signals is smaller than the average of difference values between non-interlaced horizontal lines in the chrominance signals, is greater than the number of pixels, of which average of difference values between interlaced horizontal lines in the luminance signals is greater than the average of difference values between non-interlaced horizontal lines in the luminance signals. If the previous videos include color errors, the determination unit 127 determines that the current input video will probably have a color error too.

If the color error is found in the current input video, the correction unit 300 performs chroma filtering on chrominance signals of the input video to correct the color error.

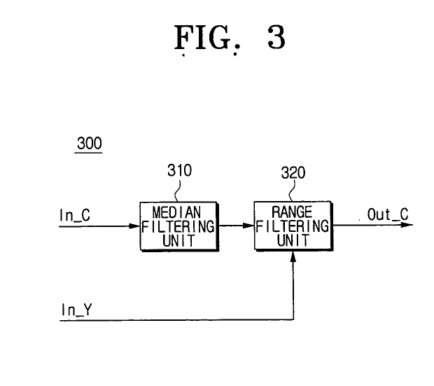

FIG. 3 is a block diagram of the correction unit 300 in FIG. 1.

Referring to FIG. 3, the correction unit 300 includes a median filtering unit 310, and a range filtering unit 320.

The median filtering unit 310 performs median filtering on every chrominance signal of an input video and determines the smallest value among color values of two vertically adjacent pixels to an error pixel corresponding to the color error as the color value for the error pixel.

The range filtering unit 320 performs filtering on median filtered chrominance signals by adaptively applying weights according to the magnitudes of luminance signals. For instance, if the luminance difference is small, a high weight is set. In this manner, it becomes possible to remove color errors in a diagonal edge and a horizontal edge that exist after median filtering.

If the color error detection unit 100 detected a color error in a current input video, the controller 200 controls the chrominance and luminance signals to be inputted to the correction unit 300 so that the color error can be corrected therein. On the other hand, if no color error was detected, non-filtered chrominance and luminance signals are outputted under the control of the control unit 200.

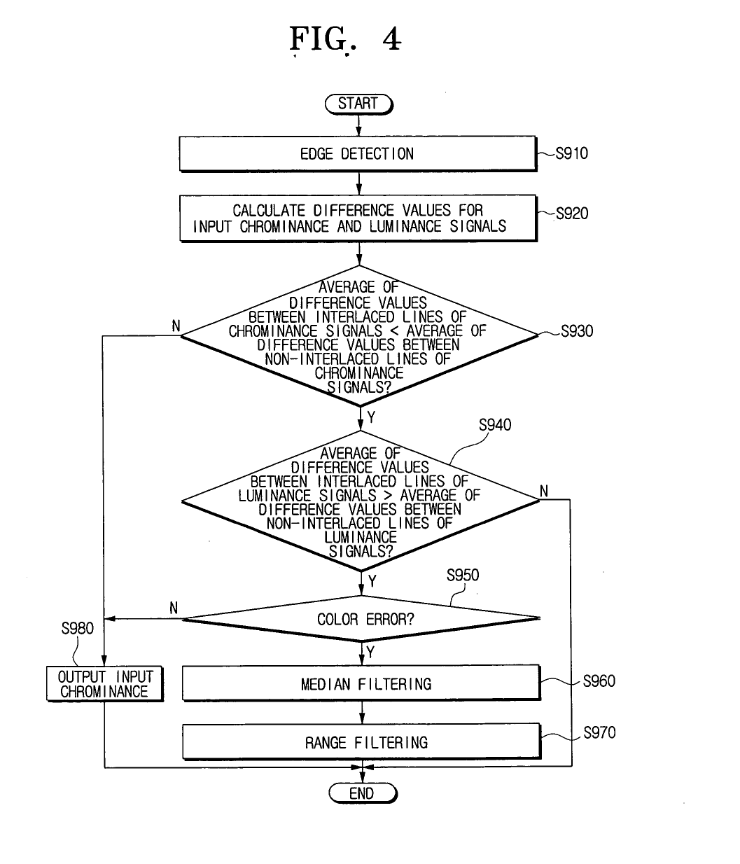

FIG. 4 is a flow chart explaining a method for correcting a color error according to one embodiment of the present invention.

Referring to FIG. 4, an edge region in an input video is detected (S910). This is so because a color error usually occurs in the edge region of the input video. For detection of an edge region, a sobel edge detector or a high pass filter may be used.

Then, an average of difference values for the chrominance and luminance signals in the detected edge region is calculated (S920). In detail, the edge region is divided into blocks, and a first average which is the average of difference values between interlaced horizontal lines of the chrominance signals, and a second average which is the average of difference values between non-interlaced horizontal lines of the chrominance signal are calculated. Moreover, a third average which is the average of difference values between interlaced horizontal lines of the luminance signals, and a fourth average which is the average of difference values between non-interlaced horizontal lines of the luminance signals are calculated.

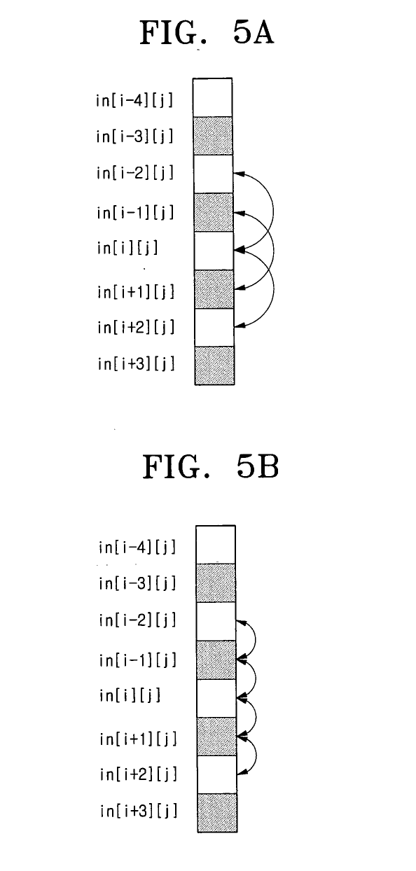

FIGS. 5A and 5B are diagrams explaining, respectively, a method for calculating an average of difference values of the chrominance and luminance signals. FIG. 5A is a diagram for explaining a method for calculating an average of difference values of the chrominance and luminance signals between interlaced horizontal lines, and FIG. 5B is a diagram for explaining a method for calculating an average of difference values of the chrominance and luminance signals between non-interlaced horizontal lines.

In FIG. 5A, the difference values of pixels of the same positions in the vertical direction with respect to the interlaced horizontal lines are averaged, whereas in FIG. 5B, the difference values of pixels of the same position in the vertical direction with respect to the non-interlaced horizontal lines are averaged.

Next, the first average and the second average are compared with each other. That is, in step S930, it is judged whether the average of difference values between interlaced horizontal lines of the chrominance signals in the edge region is smaller than the average of difference values between non-interlaced horizontal lines of the chrominance signals in the edge region.

If the average of difference values between interlaced horizontal lines of the chrominance signals is smaller than the average of difference values between non-interlaced horizontal lines of the chrominance signals (S940:Y), the third average and the fourth average are compared with each other. That is, in step S940, it is judged whether the average of difference values between interlaced horizontal lines of the luminance signals is greater than the average of difference values between non-interlaced horizontal lines of the luminance signals.

In case that the average of difference values between interlaced horizontal lines of the luminance signals is greater than the average of difference values between non-interlaced horizontal lines of the luminance signals (S940:Y), it is judged whether an input video has a color error (S950). An input video is regarded as having a color error if the result of a multiplication, i.e., the product of a constant and the number of pixels of which the average of difference values between interlaced horizontal lines in the chrominance signals is smaller than the average of difference values between non-interlaced horizontal lines in the chrominance signals, is greater than the number of pixels of which the average of difference values between interlaced horizontal lines in the luminance signals is greater than the average of difference values between non-interlaced horizontal lines in the luminance signals.

Also, an input video is regarded to have a color error if the luminance value of a certain pixel is similar to the luminance value of a vertically adjacent pixel whereas the color value of the pixel in question is not similar to the color value of a vertically adjacent pixel.

Moreover, a predetermined number of previous input videos up to the current input video are also analyzed to determine the presence or absence of a color error in the current input video. To summarize, the current input video is determined to have a color error if the luminance value of a pixel is similar to the luminance value of a vertically adjacent pixel whereas the color value of the pixel is not similar to the color value of a vertically adjacent pixel, and if the predetermined number of previous input videos have color errors. In this way, a color error in the current input video can be detected more accurately.

If it turns out that the input video includes a color error (S950:Y), median filtering is performed on the chrominance signals of the input video (S960). The smallest value among color values of two vertically adjacent pixels to an error pixel corresponding to the color error is determined as the color value for the error pixel. In this manner, it becomes possible to remove color errors in a diagonal edge.

Next, range filtering is performed on the chrominance signals of the input video (S970). In this step, weights are adaptively applied to median filtered chrominance signals according to the magnitudes of luminance signals.

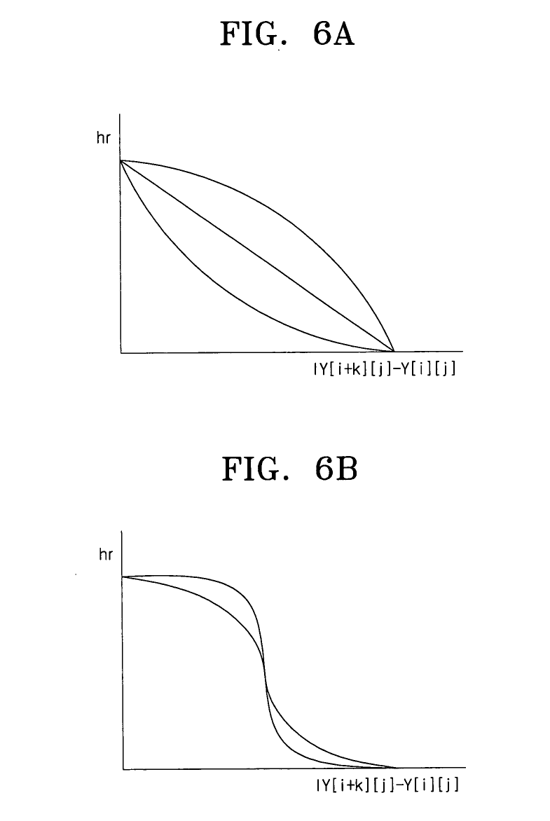

FIGS. 6A and 6B are drawings for explaining the range filtering operation. In particular, FIGS. 6A and 6B show range filtering functions with respect to luminance value differences between adjacent pixels.

As shown in the graphs of FIGS. 6A and 6B, range filtering is performed by setting high weights if the luminance value difference between adjacent pixels in the vertical direction is small. Meanwhile, there are some cases where the luminance value difference between adjacent pixels in the vertical direction is small but the adjacent pixels have different color values. This corresponds to the color edges existing in the diagonal and horizontal edges after median filtering. By performing range filtering based on the luminance difference between pixels, color errors that are not yet removed even after median filtering can be removed. The equation below expresses a range filtered input video.

$$g ( i , j ) = {k}^{- 1} ( i ) {{Q}^{1}}_{k = - 1} {h}_{r} [ y ( i + k , j ) , y ( i , j ) ] c ( i , j ) \\ {k}^{- 1} = {{Q}^{1}}_{k = - 1} {h}_{r} [ y ( i + k , j ) , y ( i , j ) ] \qquad [ Equation 1 ]$$

where, g(i, j) denotes a range filtered input video; hr denotes a range filtering function; y(i, j) denotes a luminance value of a pixel at the coordinates (i, j); and c(i, j) denotes a color value of the pixel at the coordinates (i, j).

On the other hand, if the average of difference values between interlaced horizontal lines of the chrominance signals is greater than the average of difference values between non-interlaced horizontal lines of the chrominance signals (S930: N), or if the input video does not include a color error (S950: N), the chrominance signals of the input video do not have to be filtered for correction but are outputted as they are (S980).

In effect, if the average of difference values between interlaced horizontal lines of the chrominance signals is greater than the average of difference values between non-interlaced horizontal lines of the chrominance signals (S930:N), it means that color values of adjacent pixels are similar to each other, and therefore there is no error color. Furthermore, if the average of difference values between interlaced horizontal lines of the luminance signals is smaller than the average of difference values between non-interlaced horizontal lines of the luminance signals (S940:N), it means that the color error did not result from an incorrectly upsampled color value. In this case, the chrominance signals of an input video are outputted as they are without being corrected.

As explained so far, an aspect of the present invention is capable of accurately detecting a color error, by using the relation between averages of difference values of the chrominance signals and averages of difference values of the luminance signals in the edge region of an input video. This simple, accurate color error correction consequently improves picture quality a TV.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. An apparatus for correcting a color error, comprising:
a color error detection unit configured to detect the presence or absence of a color error in an edge region of an input video, based on a relation between difference values between interlaced horizontal lines and difference values between non-interlaced horizontal lines of chrominance signals, and a relation between difference values between interlaced horizontal lines and difference values between non-interlaced horizontal lines of luminance signals;
a correction unit configured to correct the color error by performing chroma filtering on the chrominance signals of the input video, if the color edge is present in the edge region; and
a control unit configured to control the chrominance signals to be outputted after being corrected if the color error is present in the edge region, and to control the input chrominance signals to be outputted as they are if the color error is not present in the edge region.

2. The apparatus of claim 1, wherein the color error detection unit determines the presence of the color error in the edge region if an average of difference values between interlaced horizontal lines in the chrominance signals is smaller than an average of difference values between non-interlaced horizontal lines in the chrominance signals, and if an average of difference values between interlaced horizontal lines in the luminance signals is greater than an average of difference values between non-interlaced horizontal lines in the luminance signals.

3. The apparatus of claim 1, wherein the color error detection unit comprises:
an edge detection unit configured to detect an edge region in the input video;
a first calculation unit configured to calculate a first average, which is the average of difference values between interlaced horizontal lines of the chrominance signals in the edge region;
a second calculation unit configured to calculate a second average, which is the average of difference values between non-interlaced horizontal lines of the chrominance signals in the edge region;
a third calculation unit configured to calculate a third average, which is the average of difference values between interlaced horizontal lines of the luminance signals in the edge region;
a fourth calculation unit configured to calculate a fourth average, which is the average of difference values between non-interlaced horizontal lines of the luminance signals in the edge region;
a first comparison unit configured to compare the first average with the second average, and configured to compare the third average with the fourth average;
a first counter configured to count the chrominance signals if the first average is smaller than the second average;
a second counter configured to count the luminance signals if the third average is greater than the fourth average; and
a second comparison unit, which determines the presence of the color error if the result of multiplication of the counted value provided by the first counter is greater than the counted value provided by the second counter.

4. The apparatus of claim 3, wherein the color error detection unit further comprises:
a buffer configured to store color error information of the input video and of previous input videos, based on the result provided by the second comparison unit; and
a determination unit configured to determine the presence of the color error in the input video if a predetermined number of previous input videos and the input video have color errors.

5. The apparatus of claim 1, wherein the correction unit comprises:
a median filtering unit configured to perform median filtering on chrominance signals of the input video; and
a range filtering unit configured to perform range filtering on the median filtered chrominance signals by applying weights adaptively to the magnitude of the luminance signal.

6. A method for correcting a color error, the method comprising:
detecting the presence or absence of a color error in an edge region of an input video, based on a relation between difference values between interlaced horizontal lines and difference values between non-interlaced horizontal lines of chrominance signals, and a relation between difference values between interlaced horizontal lines and difference values between non-interlaced horizontal lines of luminance signals; and
correcting the color error by performing chroma filtering on the chrominance signals of the input video, if the color edge is present in the edge region.

7. The method of claim 6, wherein, in the detecting step, the presence of the color error in the edge region is determined if an average of difference values between interlaced horizontal lines in the chrominance signals is smaller than an average of difference values between non-interlaced horizontal lines in the chrominance signals, and if an average of difference values between interlaced horizontal lines in the luminance signals is greater than an average of difference values between non-interlaced horizontal lines in the luminance signals.

8. The method of claim 6, wherein the detecting step comprises:
detecting an edge region in the input video;
calculating a first average, which is the average of difference values between interlaced horizontal lines of the chrominance signals in the edge region, and a second average, which is the average of difference values between non-interlaced horizontal lines of the chrominance signals in the edge region;
calculating a third average, which is the average of difference values between interlaced horizontal lines of the luminance signals in the edge region, and a fourth average, which is the average of difference values between non-interlaced horizontal lines of the luminance signals in the edge region;
comparing the first average with the second average, and comparing the third average with the fourth average;
counting the chrominance signals if the first average is smaller than the second average;
counting the luminance signals if the third average is greater than the fourth average; and
determining the presence of the color error if the result of multiplication of the counted value of the chrominance signals is greater than the counted value of the luminance signals.

9. The method of claim 8, wherein the detecting step further comprises:
storing color error information of the input video and of previous input videos, based on a result of the comparison of the counted value of the chrominance signals to the counted value of the luminance signals; and
determining the presence of the color error in the input video if a predetermined number of previous input videos and the input video have color errors.

10. The method of claim 6, wherein the correcting step comprises:
performing median filtering on chrominance signals of the input video; and
performing range filtering on the median filtered chrominance signals by applying weights adaptively to the magnitude of the luminance signal.

11. An apparatus, comprising:
a color error detector; and
at least one adaptive filter,
wherein the color error detector detects a color error based on a relation between chrominance signals in an edge region of an input video and a relation between luminance signals in an edge region of the input video, and
wherein the adaptive filter performs adaptive filtering on the color error.

12. The apparatus of claim 11, wherein the color error detector comprises:
an edge detection unit; and
a plurality of calculation units,
wherein the edge detection unit detects an edge region of an input video, and
wherein the calculation units calculate relations between chrominance signals and relations between luminance signals.

13. The apparatus of claim 12, wherein the calculating units calculate an average of difference values between interlaced horizontal lines of the chrominance signals in the edge region, and an average of difference values between non-interlaced horizontal lines of the chrominance signals in the edge region.

14. The apparatus of claim 11, wherein the color error detector further comprises:
a plurality of counters,
wherein at least one of the plurality of counters counts chrominance signals based on a relation between chrominance signals in an edge region of an input video, and at least one other of the plurality of counters counts a relation between luminance signals based on a relation between luminance signals in an edge region of the input video.

15. The apparatus of claim 11, wherein the at least one adaptive filter comprises:
a median filtering unit; and
a range filtering unit,
wherein the median filtering unit filters chrominance signals on the input video, and
wherein the range filtering unit filters adaptively weights the median filtered chrominance signals based on luminance signal magnitudes.
